(19) United States
(12) Patent Application Publication
(10) Pub. No.: US 2014/0061183 A1
(43) Pub. Date: Mar. 6, 2014

(54) ELECTRICAL HEATING DEVICE

(71) Applicant: W.E.T. AUTOMOTIVE SYSTEMS AG, (US)

(72) Inventors: William (Wei) Li, Tianjin City (CN); Sherry (Li) Chen, Langfang City (CN); Luffy (Fei) Liu, Langfang City (CN); Jonathan (Yu) Zhang, Tianjin City (CN)

(73) Assignee: W.E.T. AUTOMOTIVE SYSTEMS AG, Odelzhausen (DE)

(21) Appl. No.: 13/791,063

(22) Filed: Mar. 8, 2013

(30) Foreign Application Priority Data
Aug. 29, 2012 (DE) 10 2012 017 047.5

(51) Int. Cl. H05B 3/34; H05B 3/03

(52) U.S. Cl. CPC H05B 3/34; H05B 3/03
USPC 219/528; 219/541

(57) ABSTRACT

The invention relates to an electrical heating device with at least one electrical heating resistor and at least one contacting device.

### BACKGROUND OF THE INVENTION

The subject matter according to the present invention is an electrical heating device according to an electrical heating device. It can be used, for example, for heating user contact surfaces, such as seats, armrests and steering wheels.

### PRIOR ART

Textile heating elements are known. The disadvantage is the quite high cost of their manufacture

Film heating elements with ah electrically conductive printed coating are also known. The disadvantage is that such heating elements are often unable to withstand use in the field.

Therefore, it is desirable to further develop the prior art, particularly with regard to a simple manufacture and a high resistance.

### SUBJECT MATTER OF THE INVENTION

Against this background, a technical concept having the characteristics of an electrical heating device having at least one electrical heating resistor and at least one contacting device. Further advantageous embodiments can be obtained from the other claims and the subsequent description.

Below, details of the invention are explained. These embodiments are intended to make the invention understandable. However, they only have the character of examples. Obviously, within the framework of the invention defined by the independent claims, one of more described characteristics can also be omitted, modified or completed. Moreover, the characteristics of different embodiments can obviously also be combined with one another. The decisive factor is that the concept of the invention is substantially implemented. If a characteristic is to be at least met in part this includes that this characteristic is also completely satisfied, or substantially completely met. “Substantially” here means in particular that the implementation allows an achievement of the desired benefit to a recognizable extent. This can mean, in particular, that a corresponding characteristic is at least 50%, 90%, 95% or 99% implemented. If a minimum amount is, indicated, then more than this minimum amount can obviously also be used. If the number of a component is indicated to he at least one, then this also includes particular embodiments having two, three or another plurality of components. A description made for an object can also be applied to the predominant portion or the totality of ail other similar objects. Unless otherwise indicated, the intervals include their end points. Below, reference is made to:

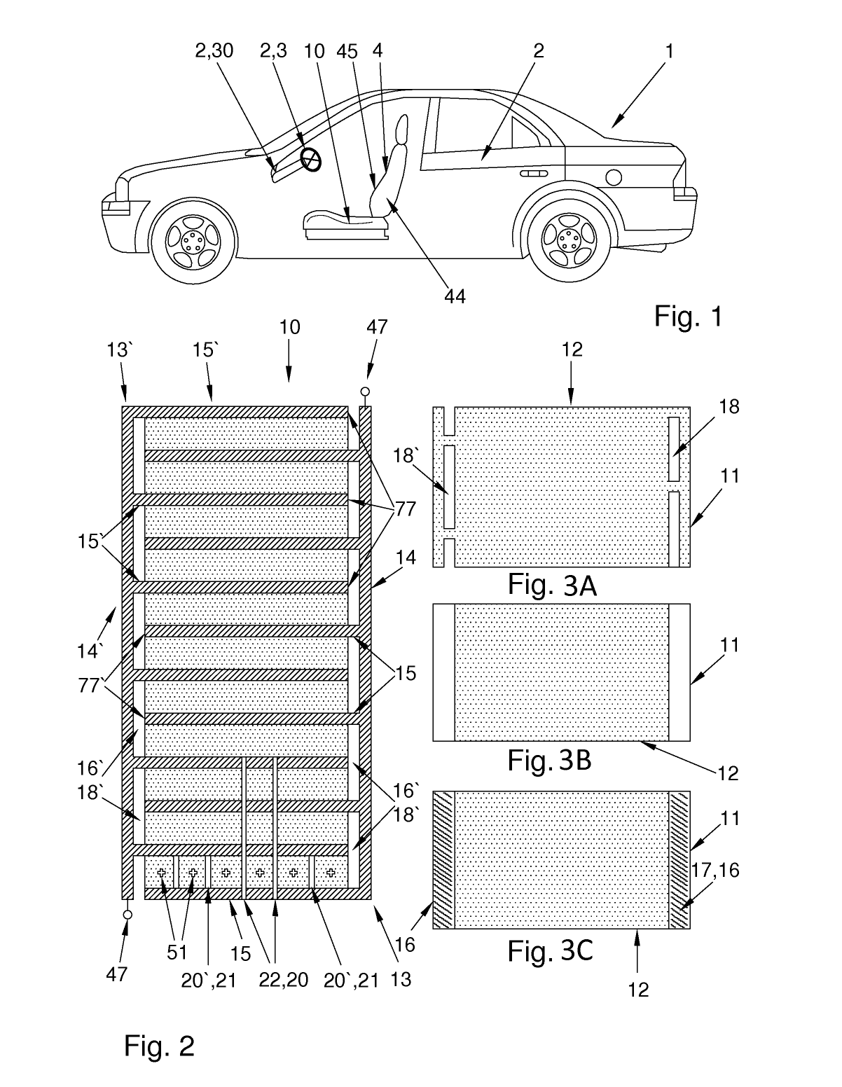

FIG. 1 Vehicle 1 with a heating device 10 according to the invention.

FIG. 2 Top view of a heating device with different variants for connecting a main electrode to a heating resistor.

FIGS. 3A-3C Top view of the heating device of FIG. 2 without contacting devices.

### DESCRIPTION

The subject matter of the invention includes a vehicle 1. A vehicle 1 denotes a device for transporting persons and/or goods. Examples are land, water, rail or air travel vehicles, particularly airplanes, ships and motor vehicles.

The invention also relates to an interior furnishing 2. An interior finishing 2 denotes a component with which the user of the passenger cell can come in contact. Examples are a steering device 3 for vehicles, a dashboard 30, an arm rest, a door lining, a seat-contact surface, a warming blanket, a roof lining, a cushion, a covering or a seat 4.

An embodiment of the invention also relates to a steering device 3. A steering device 3 denotes a device by means of which signals for steering a vehicle can be transmitted by the user to the vehicle 1. Examples are steering wheels of motor vehicles, control sticks of airplanes and/or handle bars of motorcycles.

An interior furnishing 2 preferably has a cushion 44 for a springy support for a user. A cushion denotes a device for damping impacts and/or for the distribution of local pressure peaks over a larger area. Examples are blocks made of foamed polyurethane.

An interior finishing 2 preferably has a covering 45. A covering denotes a single layer or multiple layer fabric which is arranged at least in sections on the surface of an object and/or covers the latter at least partially, particularly in order to decorate it or protect it against mechanical stress. Examples are perforated or imperforated as well as air permeable or air impermeable layers made of a film or textile.

The invention also relates to a heating device 10 for a rapid or long-lasting warming of a user or of an object-to be warmed, particularly an interior space housing, an interior portion, a seat and/or a steering wheel.

A heating device 10 denotes a device which, for the controlled warming of its environment produces thermal energy and releases it conductively, convectively and/or by heat radiation to its environment. It is positioned preferably directly on the bottom side of a covering or on the inner side of a housing lining, particularly between a cushion and a covering.

However, it is preferable but not required that a heating device 10 comprises at least one heating resistor support 11 for stabilizing a heating resistor and for a permanent positioning of the heat source. It is made preferably at least partially from a material that has a low price and/or a good thermal conductivity. Examples are polymers, particularly polyamide, polyester, polyurethane or polycarbonate. It is advantageous to use fabrics, made at least partially from a textile, knitted and crocheted fabric, knitted fabric, woven fabric, nonwoven fabric, flexible thermoplastics, air permeable material and/or a stamped or dimpled film, flat components or multiple layered composite modules. Flame retardant or self-extinguishing materials are advantageous.

Preferably a heating device 10 has at least one heating resistor 12 for a direct or indirect warming of a regulation zone. A heating resistor 12 denotes an ohmic resistance which, when current flows through it, converts electrical energy to thermal energy. Examples here are fabrics, electrically conductive layers, for example, polymer films, or metal films or coatings. Its material comprises, for example, at least portions made of aluminum, copper, gold, silver or chromium nickel, and conductive paints. It preferably has an electrical surface resistance of 10-500 ohm, particularly 50-150 ohm, and particularly 190-210 ohm. In the case of laminar heat resistances, it is possible for the heat resistance to be identical to the heat resistance support, particularly in the case of a matrix of conductive and nonconductive constituents.

Preferably, a material is selected which results in conductivity of the entire heating resistor cross section. The purpose of this is an increased ability to carry current in comparison, for example, to that achievable by printing on a nonconductive heat resistance support. Examples are conductive films made of a polymer material with conductive particles which are admixed during the manufacture of the film. It is particularly preferable to use a resin matrix consisting at least partially of PP, PE, PS, PET or PU, and to which are admixed particles or fibers with carbon, soot or metal, for example, silver, nickel, copper or tin. Combustible components should be minimized or protected by additional fire protection measures.

A heating device 10 comprises at least one contacting device 13 for connecting a heating resistor to an external supply voltage. Usually there are two contacting devices 13, 13′. However, it is also possible to use more of such contacting devices. Their shape results in a uniform current flow in the entire heating area of the heating resistor. Comb-like structures are preferred.

A contacting device 13 preferably has at least one main electrode 14, 14′. Main electrode 14 denotes a device for distributing electrical current from a current source 47 to a plurality of branch electrodes 15,15′. A suitable shape favors a low transition resistance in order to prevent hot spots, and it moreover prevents tracings on the covering top side for a high haptic comfort. Relevant examples are electrically conductive, particularly self-supporting bands. Their length corresponds preferably to the length of the longitudinal side of a cushion or of a heating resistor. Their width allows a sufficiently reliable contacting. Relevant examples are 0.2-3 cm, and particularly 0.5-2 cm.

Preferably at least one main electrode 14 has a position which results in a large-surface supply with current, wherein a direct transition from the main electrode 14 into the heating resistor 12 can be avoided if desired. Examples are, along a heating resistor:

B. at a distance from said heating resistor, on the base surface of a nonelectrically conductive heating resistor support, as in FIG. 3B;

C. on the base surface of the heating resistor, but separated from the heating resistor 12 by an electrode insulation, as in FIG. 3C, or

A. on the base surface of the heating resistor and connected in an electrically conductive manner to said heating resistor, as in FIG. 3A.

Preferably, at least one main electrode 14 comprises a metal which allows a low transition resistance between the contacting device and the heating resistor, in order to achieve a good current input and in order to prevent hot spots on electrodes. Examples are band-shaped textiles or films, which are manufactured at least partially from a conductive polymer or metal, particularly aluminum or copper, or coated therewith. Solid metal bands coated with electrically conductive or nonconductive adhesives, or layers made exclusively from such an adhesive or such a metal band are particularly well suited. In the case of an embodiment according to FIG. 3A, it is desirable for a copper film with an adhesive layer that is electrically insulating with respect to the heating resistor 12 to be applied as insulation layer on the heating resistor 12, so that the main electrode 14 can be insulated from the heating resistor 12. In addition, it is advantageous if a main electrode comprises at least two conductive layers that overlap at least partially over one another.

Preferably, at least one contacting device 13 has at least one branch electrode 15. A branch electrode 15 denotes a device for feeding a current from a main electrode into a heating resistor 12. The number of branch electrodes is preferably selected in such a manner that a large-surface distribution of the current and a generation of the correct local resistances are possible. A suitable number is between 2 and 200 pieces for each heating resistor 12, particularly one piece for each approximately 3-5 cm. The shape and the material can be selected in principle as for a main electrode 14, wherein, however, a conductive material of the branch electrode 15 is preferably different from a conductive material of the main electrode. It is particularly advantageous if a branch electrode 15 comprises at least constituents made of aluminum, and a main electrode comprises at least constituents made of copper. The branch electrodes extend preferably from a first main electrode 14, 14′ almost to a facing second main electrode 14, 14′. Their alignment extends preferably transversely to the course of the main electrode 14, 14′. In order to achieve a low transition resistance between the branch electrode 15, 15′ and its main superimposed electrode, sections, in particular one end section, of at least one branch electrode 15 are arranged between two electrically conductive layers of an associated main electrode, preferably between two copper-containing layers. Some of the participating conductive layers or all these layers can be connected to each other with an electrically conductive adhesive.

For a low transition resistance between a branch electrode 15 and a heating resistor 12 contacted by it, it is advantageous to use electrically conductive bands that are stuck, at least in sections, with an electrically conductive adhesive onto the heating resistor 12, for example, in the form of a self-adhesive band with a metal support film, or they are attached instead or additionally by sewing, lamination or injection.

It is advantageous if a heating resistor 12 or a heating resistor support 11 already contains adhesive constituents or becomes adhesive at least briefly as a result of heating or another physical or chemical treatment, and the branch electrode can be embedded therein at least partially without recourse to another material.

Preferably, a heating device 10 comprises a current diverting device 16, 16′. A current deflection device denotes any structure that diverts a current flow from a branch electrode 15 of a contacting device 13 in a main electrode 14 of another contacting device 13′ to a branch electrode 15′ of this other contacting device 13′. This results in a sufficiently high resistance between the branch electrodes of a contacting device and a main electrode 14 of another contacting device. This in turn prevents hot spots.

Preferably, a current deflection device comprises an electrode insulation 17. An electrode insulation 17 denotes any device that inhibits the passage of electrical current into or out of the main electrode. This produces an at least local insulation of a main electrode with respect to a heating resistor 12, so that no current is fed there from this main electrode directly into the heating resistor 12, but only through branch electrodes supplied by the main electrode. This too prevents hot spots. Suitable materials are, for example, insulation layers made of electrically nonconductive films, nonconductive adhesives or air gaps and separations of an electrode with respect to a heating resistor 12. It is preferable to use double-sided adhesive bands with an insulating support layer or layers made of nonconductive adhesive on the electrode and/or the heating resistor 12. It is easy to manufacture layers that are arranged in a sandwich-like pattern between a heating resistor 12 and a main electrode arranged above the base surface of said heating resistor.

Preferably, a current deflection device 16, 16′ comprises a pole separation device 18, 18′, in order to produce a sufficient electrical separation of two oppositely poled contacting devices Examples are material recesses, stamped out sections, and separations or barrier resistances in a heating resistor material or between two contacting devices, particularly between the main electrode 14 and a tip 77 of an opposite poled branch electrode 15.

The width of a pole separation device 18 is selected such that, on the one hand, the branch electrode 15 of a contacting device 13 is as close as possible to the main electrode of an opposite poled contacting device, while a reliable pole separation is provided at the same time. The purpose is an optimal use of the material of the heating resistor. Examples are 1-15 mm, particularly 2-7 mm, and particularly 3-5 mm. Here, the shortest bypass path to bypass the pole separation device 18 should be at least as long as the shortest separation between two counter oppositely poled branch electrodes on the heating resistor 12.

Preferably, a heating device 10 has a protective sheath (not shown) for covering the heating device towards the covering and/or towards the cushion. The effect of this is protection from mechanical damage and from corrosion, and/or decoration or insulation. Examples are textiles, such as nonwoven fabrics, or films, which are formed at least partially by waterproof materials such as PE, PP, PU or PET. In the case of an appropriate selection, they can also be flame retardant or self-extinguishing.

Preferably, a heating device 10 has a comfort perforation 51 for permeability to air and moisture, and an adjusted heating resistor value. Examples are circular, oval or longitudinal holes in the heating device 10, particularly in a heating resistor 12.

Preferably, a heating device 10 comprises a flame retardant device 20, 20′. A flame retardant device 20 denotes a device that extinguishes a fire, or delays or deflects its propagation.

The flame retardant device 20 preferably has a fire propagation blocker 22 for extinguishing or pushing away flames or embers, on the propagation blocker, for example, in the form of incombustible or self-extinguishing material bands or strips. Their arrangement occurs particularly transversely to at least one branch electrode 15, preferably with parallel offset with respect to a main electrode and over several branch electrodes. Suitable materials are metals, particularly aluminum.

Preferably, a flame retardant device 20 has a flame retardant recess 21, which, in terms of a fire, means removal of combustible material, and thus produces a delay or the extinguishing of the fire, in a cost saving manner. Examples are gaps with a width of 5 mm or more in a heating resistor 12 or in a component that works together with said resistance.

1. An electrical heating device comprising: at least one electrical heating resistor and at least one contacting device.

2. The heating device according to claim 1, wherein the heating resistor is manufactured at least partially from a combustible material and in that the heating device comprises at least one flame retardant device.

3. The heating device according to claim 1, wherein the heating resistor is provided with at least one flame retardant recess.

4. The heating device according to claim 1, wherein the heating resistor is provided with at least one fire propagation blocker, which is formed at least partially by a noncombustible or a self-extinguishing material.

5. The heating device according to claim 1, wherein the contacting device comprises a main electrode and several branch electrodes that branch off from the main electrode.

6. The heating device according to claim 1, wherein at least one contacting device comprises at least two electrically conductive layers that overlap at least partially over one another.

7. The heating device according to claim 1, wherein the contacting device comprises at least one self-supporting band, which is stuck to an electrical heating resistor.

8. The heating device according to claim 1, wherein the contacting device comprises a main electrode with a first conductive material, and in that the contacting device comprises branch electrodes branching off the main electrode, branch electrodes which are formed at least partially by a second conductive material that is chemically different from the first conductive material of the main electrode.

9. An air conditioning device, wherein the air conditioning device comprises at least one heating device according to claim 1.

10. A vehicle, wherein the vehicle comprises at least one heating device according to claim 1.

11. The heating device according to claim 2, wherein the heating resistor is provided with at least one flame retardant recess.

12. The heating device according to claim 2, wherein the heating resistor is provided with at least one fire propagation blocker, which is formed at least partially by a noncombustible or a self-extinguishing material.

13. The heating device according to claim 11, wherein the heating resistor is provided with at least one fire propagation blocker, which is formed at least partially by a noncombustible or a self-extinguishing material.

14. The heating device according to claim 13, wherein the contacting device comprises a main electrode and several branch electrodes that branch off from the main electrode.

15. The heating device according to claim 14, wherein at least one contacting device comprises at least two electrically conductive layers that overlap at least partially over one another.

16. The heating device according to claim 13, wherein the contacting device comprises at least one self-supporting band, which is stock to an electrical heating resistor.

17. The heating device according to claim 15, wherein the contacting device comprises at least one self-supporting band, which is stuck to an electrical heating resistor.

18. The heating device according to claim 14, wherein the contacting device comprises a main electrode with a first conductive material, and in that the contacting device comprises branch electrodes branching off the main electrode, branch electrodes which are formed at least partially by a second conductive material that is chemically different from the first conductive material of the main electrode.

19. The heating device according to claim 15, wherein the contacting device comprises a main electrode with a first conductive material, and in that the contacting device comprises branch electrodes branching off the main electrode, branch electrodes which are formed at least partially by a second conductive material that is chemically different from the first conductive material of the main electrode.

20. An electrical heating device comprising:
a. at least one electrical heating resistor including:
i. at least one flame, retardant recess,
ii. at least one fire propagation blocker, which is formed at least partially by a noncombustible or a self-extinguishing material, and
b. at least one contacting device including:
i. at least two electrically conductive layers that overlap at least partially over one another,
ii. at least one self-supporting band, which is stuck to an electrical heating resistor,
iii. a main electrode with a first conductive material, and in that the contacting device comprises branch electrodes branching off the main electrode, branch electrodes which are formed at least partially by a second conductive material that is chemically different from the first conductive material of the main electrode
wherein the heating resistor is manufactured at least partially from a combustible material and in that the heating device comprises at least one flame retardant device.
